(19) United States
(12) Patent Application Publication
(10) Pub. No.: US 2004/0069049 A1
(43) Pub. Date: Apr. 15, 2004

(54) Viscosity testing and stirring device

(76) Inventor: Stanley D. Neal, Mt. Juliet, TN (US)

Correspondence Address: Lorri W. Cooper, Jones, Day, Reavis & Pogue, 901 Lakeside Avenue, Cleveland, OH, 44114, US

(21) Appl. No.: 10/267,611

(22) Filed: Oct. 9, 2002

(51) Int. Cl. G01N 11/00

(52) U.S. Cl. 73/54.01

(57) ABSTRACT

A viscosity testing and stirring device includes a rigid, elongated member having a viscosity testing opening defined therethrough. In one embodiment, the member has a generally V-shaped cross-section along at least a portion of its length. In another embodiment, the member has a tear-drop shaped opening. In yet another embodiment, the member has a non-flat cross-section along at least a portion of its length. The member functions as a stirrer and the opening is used to test the viscosity of a liquid. A method for testing the viscosity of a liquid is also provided.

### FIELD OF THE INVENTION

The claimed invention relates to a stirring device that is utilized for stirring a medium and for testing the viscosity of the medium to determine if the viscosity is within an acceptable range.

### BACKGROUND OF THE INVENTION

In the use of an airless paint sprayer, paint is poured from a can of paint into a paint cup that is attached to a housing of the paint sprayer. The paint in the paint cup is suctioned through the paint sprayer housing and sprayed out a nozzle for application of the paint to a surface. Depending upon the design of the sprayer, the nature of the paint, and the coverage desired, the paint must be within a preferred viscosity range.

The viscosity of commercially available paints can vary. As a result, it is desirable to test the viscosity of the paint to determine whether it is in the preferred range in order to insure proper operation of the paint sprayer and proper application of the paint. If the viscosity is too low (so that the paint is too thick), the user can add water or paint thinner, depending on the type of paint, and stir the water or paint thinner into the paint in order to obtain a uniform mixture. The user may then retest the viscosity to confirm the paint is within the preferred range prior to operation of the sprayer.

### SUMMARY

A viscosity testing and stirring device comprises a rigid, elongated member having a viscosity testing opening defined therethrough. The member has a generally V-shaped cross-section along at least a portion of its length. The member functions as a stirrer and the opening is used to test the viscosity of a liquid. In an alternative embodiment, the member has a non-flat cross-section.

In yet another embodiment, a viscosity testing and stirring device comprises an elongated member having a viscosity testing opening defined through the member. The viscosity testing opening is tear-drop shaped and is used to test the viscosity of a liquid.

In a further embodiment, a method of testing the viscosity of a liquid includes providing an elongated member having an opening defined therethrough and inserting the member into a liquid so that the opening of the member is completely submerged within me liquid. The method also includes removing the member from the liquid so that the liquid forms a sheet of liquid that fills the opening. The method further includes counting the time from removal of the member from the liquid until the liquid sheet pops and determining if the time for popping occurs within a specified time.

### BRIEF DESCRIPTION OF THE DRAWING FIGURES

FIG. 1 is a perspective view of a viscosity testing and stirring device according to the invention;

FIG. 2 is side view of the viscosity testing and stirring device shown in FIG. 1;

FIG. 3 is a tip end view of the viscosity testing and stirring device shown in FIG. 1;

FIG. 4 is cross-sectional view of the viscosity testing and stirring device taken at line 4-4 in FIG. 1;

FIG. 5 is a perspective view of an alternative embodiment of the viscosity testing and stirring device according to the invention; and

FIG. 6 is a tip end view of the viscosity testing and stirring device of FIG. 5.

### DETAILED DESCRIPTION OF THE INVENTION

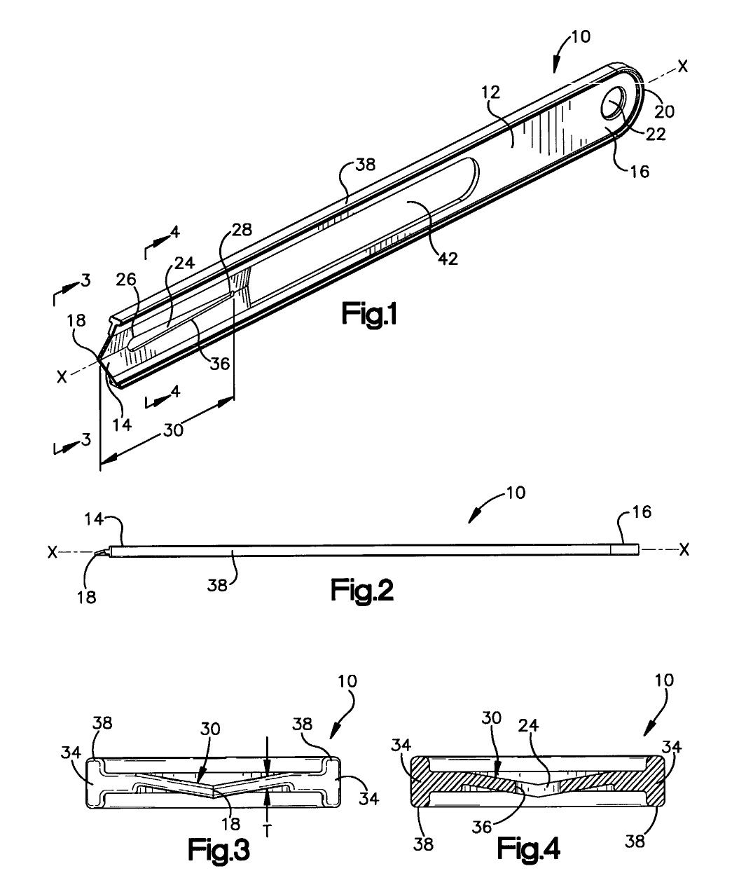

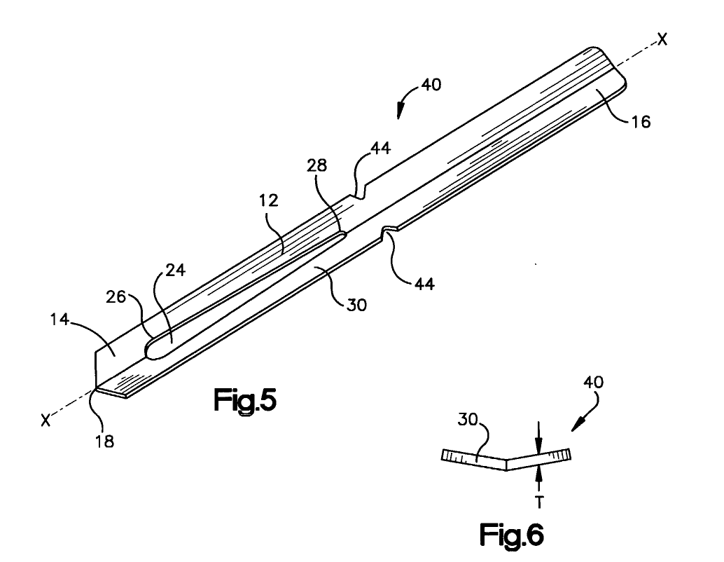

A viscosity testing and stirring device 10, 40 is shown in FIGS. 1-6. FIGS. 1-4 depict a device 10 that, in a preferred embodiment, is formed of a plastic material. FIGS. 5 and 6 depict a device 40 of another embodiment that can be formed of a metal material, for example. The various embodiments depicted herein can be made of a metal material, a plastic material, or other materials provided that it is preferred that the material utilized imparts enough rigidity to the device to allow it to stir a liquid.

A viscosity testing and stirring device 10, 40 is utilized to test the viscosity of a liquid. It may also be used to stir the liquid. An example of an intended application for the device 10, 40 is to test and stir paint to be used in an airless paint sprayer. Airless paint sprayers pump paint from a reservoir and spray the paint onto a surface. In order for the paint sprayer to work effectively, the paint must be thin enough (or have a viscosity that is high enough) so that the paint is easily sprayed through the paint sprayer. If the paint is too thick, or has a viscosity that is too low, the paint sprayer will not operate properly. Thus, it is often desirable to test the paint to be used with a paint sprayer before the actual paint spraying operation begins. The device 10, 40 of the present invention may be utilized to both test the viscosity of paint and to stir the paint. Thus, the device 10, 40 is a multi-purpose tool. While the invention is discussed herein in the context of paint, other types of liquids may also be tested and stirred with the device, such as stains, lacquers, and the like, the invention not being limited to use with paint.

Referring to FIGS. 1-4, a viscosity testing and stirring device 10 comprises a rigid, elongated shank 12 having a longitudinal axis X-X. The shank 12 has a tip end 14 and a second end 16. The tip end 14 is for inserting into the paint and the second end 16 is for gripping by the user during stirring and testing. The tip end 14 has a pointed tip 18, although it may take on other shapes. The pointed tip is useful in directing paint to channel off the shaft, which helps the paint to be removed from the shaft more quickly. The second end 16 has a rounded portion 20, which makes the shank easier to grip by a user. A hole 22 is positioned through the second end and can be used for hanging the device during non-use. The second end may also take on other shapes and is not limited to the shape depicted.

The device 10 also includes a viscosity testing opening 24 positioned through the shank 12 near the tip end 14. As shown in FIG. 1, the viscosity testing opening 24 is positioned along the longitudinal axis X-X of the shank and is elongated. In a preferred embodiment, the viscosity testing opening 24 is tear-drop shaped, with the widest end 26 of the tear-drop positioned adjacent the tip end 14 and the narrower end 28 of the tear drop positioned toward the second end 16 of the shank 12.

The shank 12 includes a portion that has a V-shaped cross-section 30, as shown best in FIGS. 1, 3, and 4. The viscosity testing opening 24 is positioned within the V-shaped cross-section 30. The V-shaped cross-section 30 extends along a portion of the length of the shank 12. In addition to having a V-shaped cross-section 30, the cross-section of the shank 12 may have a tapered surface (not shown) that tapers from the outer side walls 34 of the shank 12 to the viscosity testing opening 24, or may be a constant thickness T, as shown in FIG. 3.

The shank 12 may also include an outer reinforcing member 38 that extends around the perimeter of the shank 12. As shown in FIGS. 1, 3, and 4, in one embodiment, the reinforcing member 38 is a rib that extends along the side wails 34 and around the second end 16 of the shank 12 in a continuous rib. Another opening 42 may extend through the shank. This second opening 42 may be used to reduce the amount of material that is used to manufacture the device 10 during the plastic molding process. The second opening 42 may also be used to reduce drag in order to allow the device 10 to move more easily through the paint during stirring.

In a preferred embodiment, the shaft 12 of FIG. 1 has a length of approximately 12 inches. The V-shaped cross-section portion 30 has a length of approximately 3.3 inches and the viscosity testing opening 24 has a length of approximately 2.3 inches. The widest part of the viscosity testing opening 24 has a width of about ¼ inches. The second opening 42 has a length of approximately 5 inches and the shaft has a width of about 1¼ inches. The dimensions may vary from these dimensions, which are provided for illustration purposes only.

An alternative embodiment of the viscosity testing and stirring device 40 is shown in FIGS. 5 and 6. The device 40 includes a rigid, elongated shank 12 having a longitudinal axis X-X. The shank 12 has a tip end 14 and a second end 16. The tip end 14 is for inserting into a liquid, such as paint, and the second end 16 is for gripping by the user during stirring and testing. The tip end 14 is shown as having a pointed end 18, although it may take on other shapes. The tip end 14 and the second end 16 are separated by notches 44 that extend inwardly from the side walls 34.

A viscosity testing opening 24 is positioned through the shank 12 in the tip end 14 of the shank. As shown in FIG. 5, the viscosity testing opening 24 is aligned with the longitudinal axis X-X of the shank 12 and is elongated. In a preferred embodiment, the viscosity testing opening 24 is tear-drop shaped, with the wider end 26 of the tear drop positioned adjacent the tip end 14 and the narrower end 28 of the tear drop positioned near the notches 44. The shank 12 has a V-shaped cross-section 30 along its length, as shown in FIG. 6. In addition, the wall thickness T of the shank 12 is generally uniform. In a preferred embodiment, the shank of FIGS. 5 and 6 is made from a metal material, although it may alternatively be made of a plastic or other material.

The invention also concerns a method of testing the viscosity of a liquid, such as paint. According to the method, the user utilizes the device 10, 40 to stir the paint by inserting it into a paint reservoir and stirring the paint in the reservoir in a conventional manner. Once the paint has been properly stirred so as to have a uniform consistency, the user inserts the tip end 14 of the device longitudinally into the paint reservoir. The user then withdraws the device from the paint. During withdrawal, a paint sheet will form over the viscosity testing opening 24 and cling to the perimeter 36 of the opening to form a sheet. The device 10, 40 is held vertically so that the tip end 14 is positioned directly below the second end 16. The paint will slowly drip off of the tip end 14 of the device 10, 40 and, eventually, the paint sheet that has formed over the viscosity testing opening 24 will break or pop so that the sheet is no longer formed over the opening 24 and the user can see through the opening.

After the user removes the device from the paint, the user counts the seconds until the sheet of paint over the viscosity testing opening 24 pops or breaks. The paint is within a desired viscosity range if the paint sheet breaks within a specified time period, such as, for example, ten seconds or less. If the paint sheet breaks within the specified time, the paint is ready for use with a paint sprayer in a conventional manner.

If the paint sheet breaks in a time period that is greater than the specified time, or doesn't break or pop at all, the user needs to thin the paint since the viscosity of the paint is too low. The user adds a thinner to the paint and stirs it with the device until it reaches a uniform consistency. The user then inserts and withdraws the device 10, 40, as discussed above, and counts the time until the paint sheet pops. If the paint sheet pops within the specified time period, the paint is ready to use with a paint sprayer. If the paint again is too thick, the above steps are repeated until a desired viscosity is obtained.

Each of the embodiments described above depicts a viscosity testing opening 24 that is tear-drop shaped. While a preferred viscosity testing opening is tear-drop shaped, other shaped openings may also be utilized with the invention. Furthermore, differently sized shanks may be utilized with the invention. For instance, a longer shank may be preferred when the paint reservoir is a gallon can of paint while a shorter shank may be preferred when the paint reservoir is a quart size paint cup that is attached to a paint sprayer. In addition, the V-shaped cross-section 30 may take on other shapes, such as curved or rounded, the invention not being limited to a particular shape for every embodiment. Furthermore, some embodiments of the invention may include a shank that is flat along its length.

While various features of the claimed invention are presented above, it should be understood that the features may be used singly or in any combination thereof. Therefore, the claimed invention is not to be limited to only the specific embodiments depicted herein.

Further, it should be understood that variations and modifications may occur to those skilled in the art to which the claimed invention pertains. The embodiments described herein are exemplary of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. A viscosity testing device comprising:
a rigid, elongated member having a viscosity testing opening defined therethrough, said member having a generally V-shaped cross-section along at least a portion of its length, whereby the member functions as a stirrer and the viscosity testing opening is used to test the viscosity of a liquid.

2. The device of claim 1, wherein the member is a shaft.

3. The device of claim 2, wherein the shaft has a tip end and a second end, with the viscosity testing opening defined in the vicinity of the tip end and a grippable portion defined at the second end.

4. The device of claim 3, wherein the V-shaped cross-section is in the vicinity of the tip end and the viscosity testing opening is positioned within the V-shaped cross-section.

5. The device of claim 1, wherein the viscosity testing opening is elongated.

6. The device of claim 3, wherein the viscosity testing opening is tear drop shaped.

7. The device of claim 6, wherein the tear drop shaped viscosity testing opening has a widest end near the tip end.

8. The device of claim 3, wherein the shaft is pointed at the tip end and rounded at the second end.

9. The device of claim 1, wherein the member has a constant thickness within the V-shaped cross-section.

10. The device of claim 3, wherein the shaft has outer side edges and includes a reinforcing rib positioned around the outer side edges and the second end of tile shaft.

11. The device of claim 1, wherein the member is made from a metal or a plastic material.

12. The device of claim 1, wherein the V-shaped cross-section extends along the entire length of the shaft.

13. A viscosity testing device comprising:
an elongated member having a viscosity testing opening defined through the member, said viscosity testing opening being tear-drop shaped, whereby the viscosity testing opening is used to test the viscosity of a liquid.

14. The device of claim 13, wherein the viscosity testing opening is elongated.

15. The device of claim 14, wherein the member is a shank having a tip end and a second, grippable end, the viscosity testing opening is positioned in the vicinity of the tip end, and the viscosity testing opening has a longitudinal axis that aligns with a longitudinal axis of the shank.

16. The device of claim 13, wherein the tear-drop shaped viscosity testing opening has a wider bottom end and a narrower top end, and the bottom end of the viscosity testing opening is positioned closer to the tip end of the shank than the narrower top end of the viscosity testing opening.

17. The device of claim 13, wherein the member has a uniform thickness.

18. A viscosity testing device comprising:
a rigid, elongated member having a viscosity testing opening defined therethrough, said member having a non-flat cross-section along at least a portion of its length, whereby the member functions as a stirrer and the viscosity testing opening is used to test the viscosity of a liquid.

19. A method of testing the viscosity of a liquid comprising:
providing an elongated member having an opening defined therethrough;
inserting the member into a liquid so that the opening of the member is completely submerged within the liquid;
removing the member from the liquid so that the liquid forms a sheet of liquid that fills the opening;
counting the time from removal of the member from the liquid until the liquid sheet pops through the opening;
determining if the time for popping occurs within a specified time.

20. The method of claim 19, wherein the specified time is ten seconds or less.

21. The method of claim 19, wherein if the popping does not occur within the specified time, further comprising:
adding a thinning material to the liquid;
stirring the liquid with the member; and
repeating the inserting, removing, counting, and determining steps.

22. The method of claim 19, wherein the member has a tip end and a second end, and further comprising, after the removing step, holding the member at the second end with the tip end down.

23. The method of claim 19, further comprising stirring the liquid with the member.
